(19) United States
(12) Patent Application Publication
(10) Pub. No.: US 2026/0258747 A1
(43) Pub. Date: Sep. 3, 2026

(54) VEHICLE AND COOLING MEMBER

(71) Applicant: Isuzu Motors Limited, Yokohama-shi (JP)

(72) Inventors: Hideki TOYA, Fujisawa-shi, Kanagawa (JP); Fumiya SAKEI, Fujisawa-shi, Kanagawa (JP); Yoshihiro OKOSHI, Fujisawa-shi, Kanagawa (JP); Masaya SUZUKI, Fujisawa-shi, Kanagawa (JP)

(73) Assignee: Isuzu Motors Limited, Yokohama-shi (JP)

(21) Appl. No.: 18/832,533

(22) PCT Filed: Sep. 15, 2022
(86) PCT No.: PCT/JP2022/034546

§ 371 Date: Jul. 24, 2024

(30) Foreign Application Priority Data
Jan. 28, 2022 (JP) 2022-011954

(51) Int. Cl. F01P 1/08

(52) U.S. Cl. CPC F01P 1/08

(57) ABSTRACT

Provided are a vehicle and a cooling member that can efficiently cool a valve. In the vehicle, the valve is provided on the rear side of a turbocharger in the vehicle length direction and below the top surface of the turbocharger in the vehicle height direction. The vehicle comprises a wind guide member provided between the turbocharger and the valve in the vehicle length direction and having a shape that guides, to the valve, the wind blowing from the front side to the rear side in the vehicle length direction above the turbocharger.

### TECHNICAL FIELD

The present disclosure relates to a vehicle including a valve and a cooling member.

### BACKGROUND ART

In the related art, it is known that an internal combustion engine of a vehicle includes a cam shaft for driving a suction valve or an exhaust valve, a variable valve timing mechanism attached to the cam shaft to adjust the rotational phase of the cam shaft with respect to a crankshaft, and a valve that adjusts the amount of oil to be supplied to the variable valve timing mechanism, for example.

For example, PTL 1 discloses a vehicle including a valve disposed on the exhaust side of the internal combustion engine.

### CITATION LIST

### Patent Literature

PTL 1

Japanese Patent Application Laid-Open No. 2000-282822

### SUMMARY OF INVENTION

### Technical Problem

In the above-mentioned vehicle, however, the temperature of the valve disadvantageously increases when receiving the heat of components around the valve (e.g., turbocharger, exhaust manifold, exhaust gas cleaning apparatus and the like).

An object of the present disclosure is to provide a vehicle and a cooling member that can efficiently cool the valve.

### Solution to Problem

A vehicle according to an aspect of the present disclosure includes an internal combustion engine including a variable valve timing mechanism configured to change an opening/closing timing of a suction valve or an exhaust valve by driving a valve; and a turbocharger that compresses gas with a compressor on the same axis by rotating a turbine with exhaust gas from the internal combustion engine, and sends the gas into the internal combustion engine. The valve is provided on a rear side than the turbocharger in a vehicle length direction and on a lower side than a top surface of the turbocharger in a vehicle height direction. The vehicle further comprises an air introduction member provided between the turbocharger and the valve in the vehicle length direction and having a shape that guides, to the valve, air flowing on an upper side of the turbocharger from a front side toward a rear side in the vehicle length direction.

A cooling member according to an aspect of the present disclosure includes an internal combustion engine including a variable valve timing mechanism configured to change an opening/closing timing of a suction valve or an exhaust valve by driving a valve; and a turbocharger that compresses gas with a compressor on the same axis by rotating a turbine with exhaust gas from the internal combustion engine, and sends the gas into the internal combustion engine. The valve is provided on a rear side than the turbocharger in a vehicle length direction and on a lower side than a top surface of the turbocharger in a vehicle height direction. The cooling member has a shape that guides, to the valve, air flowing on an upper side of the turbocharger from a front side toward a rear side in the vehicle length direction.

### Advantageous Effects of Invention

According to the present disclosure, the valve can be efficiently cooled.

### BRIEF DESCRIPTION OF DRAWINGS

FIG. 1 is a perspective view illustrating a configuration of a region around a turbocharger in a vehicle according to an embodiment of the present disclosure;

FIG. 2 is an enlarged view of FIG. 1;

FIG. 3 is a sectional view taken along line a-a of FIG. 2; and

FIG. 4 is a perspective view illustrating a protruding portion of an air introduction member according to the embodiment of the present disclosure.

### DESCRIPTION OF EMBODIMENTS

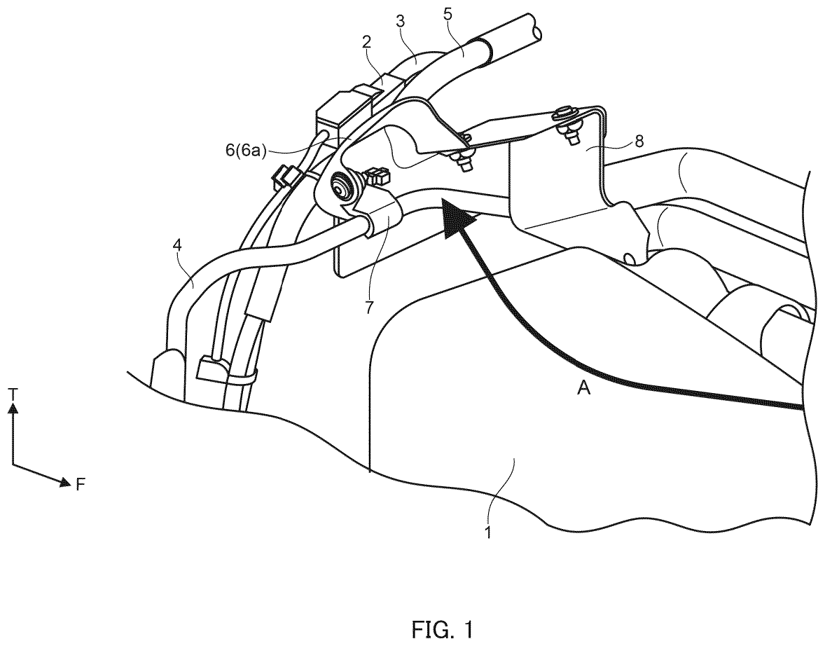

An embodiment of the present disclosure is described below with reference to FIGS. 1 to 4. In each figure, common components are indicated with the same symbol, and their explanations are omitted as appropriate.

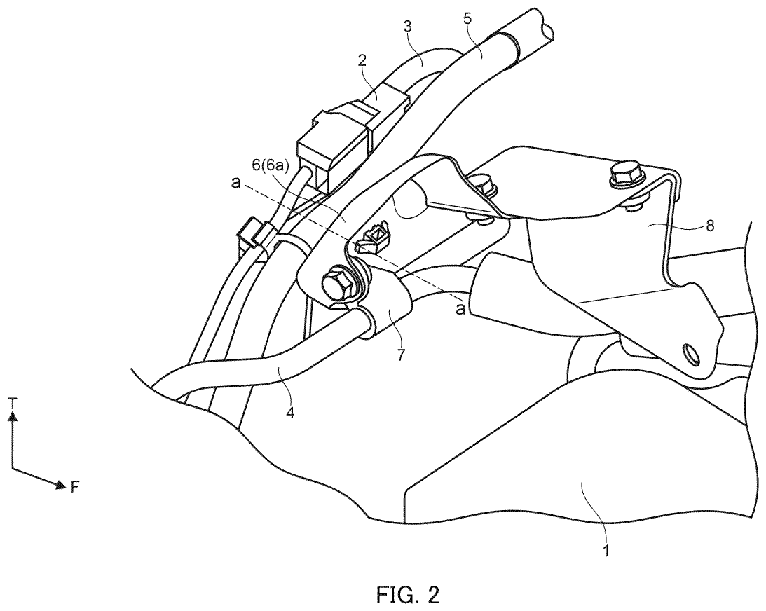

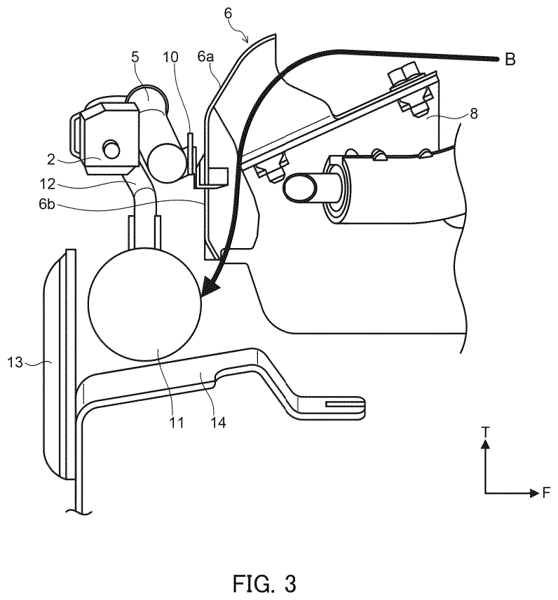

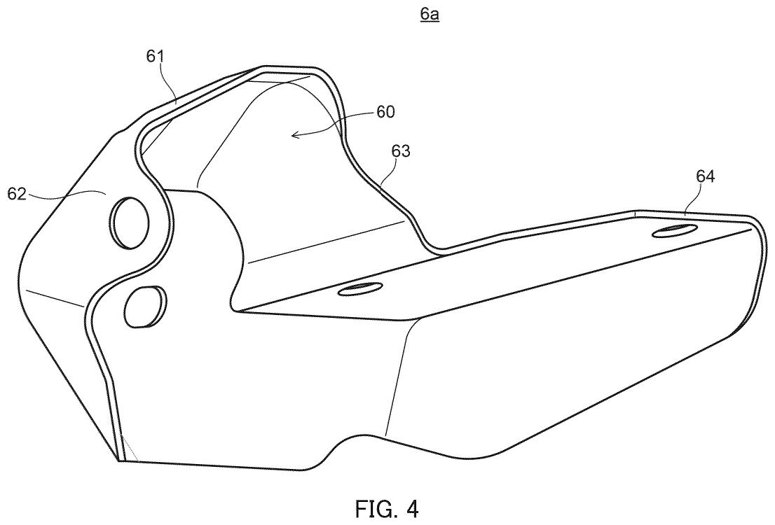

FIG. 1 is a perspective view illustrating a configuration of a region around a turbocharger of a vehicle. FIG. 2 is an enlarged view of FIG. 1. FIG. 3 is a sectional view taken along line a-a of FIG. 2. FIG. 4 is a perspective view illustrating a protruding portion of an air introduction member. In addition, in FIGS. 1 to 3, arrow F indicates the front side in the vehicle length direction (the front-rear direction of the vehicle body), and arrow T indicates the upper side in the vehicle height direction (the up-down direction of the vehicle body).

A vehicle (e.g., an automobile) includes an internal combustion engine, an exhaust manifold, an exhaust gas cleaning apparatus and the like not illustrated in the drawing, in addition to the components illustrated in FIGS. 1 to 4.

The internal combustion engine includes a cam shaft (not illustrated), a variable valve timing mechanism (not illustrated), oil control valve 11 (see FIG. 3) and the like. The cam shaft drives a suction valve (not illustrated) or an exhaust valve (not illustrated). The variable valve timing mechanism is attached to the cam shaft to change the opening/closing timing of the suction valve or the exhaust valve by adjusting the rotational phase of the cam shaft with respect to the crankshaft (not illustrated). Oil control valve 11 adjusts the oil pressure used at the variable valve timing mechanism.

Oil control valve 11 (an example of the valve) is provided on the rear side than the turbocharger 1 in the vehicle length direction and provided on the lower side than the top surface of turbocharger 1 in the vehicle height direction (see FIG. 3).

Turbocharger 1 compresses the gas with a compressor (not illustrated) on the same axis by rotating the turbine (not illustrated) with the exhaust gas from the internal combustion engine, and sends it into the internal combustion engine.

On the rear side of turbocharger 1, exhaust temperature sensor 2 that detects the temperature of the exhaust gas flowing through the exhaust gas cleaning apparatus, wire harness (branch line) 3 that supplies power to exhaust temperature sensor 2, vacuum pipe 4 that guides the negative pressure to the exhaust brake (not illustrated), wire harness (trunk line) 5 that supplies power to turbocharger 1, exhaust temperature sensor 2, and oil control valve 11 and the like, wire harness 12 that supplies power to oil control valve 11, and the like. The above-described components are common components in the related art, and therefore the description thereof is omitted.

In the vehicle of the present embodiment, air introduction member 6 (an example of the cooling member) as a characteristic component is provided on the rear side of turbocharger 1.

Air introduction member 6 is provided between turbocharger 1 and oil control valve 11 in the vehicle length direction (see FIG. 3).

Air introduction member 6 has a shape that guides to oil control valve 11 the air flowing from the front side to the rear side in the vehicle length direction on the upper side of turbocharger 1 (see arrow A of FIG. 1). This air is an air with a relatively low temperature and a high flow velocity that flows between the internal combustion engine and the cab floor (not illustrated) toward the rear side from the downstream side of the radiator fan (not illustrated) provided on the front side in the vehicle length direction, for example.

As illustrated in FIGS. 1 to 3, air introduction member 6 includes protruding portion 6a that protrudes upward than the top surface of turbocharger 1 in the vehicle height direction, and flat portion 6b provided on the lower side than protruding portion 6a in the vehicle height direction and extended along the vehicle height direction. Protruding portion 6a and flat portion 6b are formed by bending and processing a single plate-shaped member, for example.

As illustrated in FIG. 4, protruding portion 6a includes opening 60, top surface portion 61, side portions 62 and 63, and extending portion 64.

Opening 60 faces the air flow direction (see arrow A of FIG. 1) and functions as an air inlet

The upward direction side of opening 60 is surrounded with top surface portion 61, and the left-right direction side of opening 60 is surrounded with side portions 62 and 63. In this manner, the air having entered air introduction member 6 from opening 60 can be prevented from diffusing to the vehicle width direction (left-right direction) side and/or the upper side in the vehicle height direction, and the air can be efficiently taken.

Extending portion 64 has a shape that extends in the horizontal direction (vehicle width direction) from the lower end of side portion 63, with the tip end bent downward. In this manner, the air can be taken also from the lower side of extending portion 64.

As illustrated in FIG. 4, side portion 62 and extending portion 64 are provided with a bolt hole (whose reference numeral is omitted) to which a bolt is inserted.

As illustrated in FIGS. 1 and 2, a bolt (whose reference numeral is omitted) is inserted to the bolt hole of side portion 62, and side portion 62 is fastened to bracket 7 with a bolt. In addition, as illustrated in FIGS. 1 and 2, bracket 7 is attached to vacuum pipe 4.

As illustrated in FIGS. 1 to 3, a bolt (whose reference numeral is omitted) is inserted to the bolt hole of extending portion 64, and extending portion 64 is fastened to bracket 8 with a bolt. Although not illustrated in the drawings, a lower portion of bracket 8 is fixed to a cam carrier (not illustrated).

As illustrated in FIG. 3, protruding portion 6a is tilted to the front side in the vehicle length direction with respect to the extending direction of flat portion 6b as the reference. In this manner, the air can be easily taken into protruding portion 6a, and the air having flown into protruding portion 6a can be smoothly guided to the lower direction (the direction of flat portion 6b).

The air having flown into protruding portion 6a flows in the lower direction along flat portion 6b to be guided to oil control valve 11, and then makes contact with oil control valve 11 (see arrow B of FIG. 3).

Components that can have a high temperature are located near a front portion (a right side portion of FIG. 3) and a lower portion of oil control valve 11, and these portions are susceptible to heat. In view of this, as illustrated in FIG. 3, the lower end of flat portion 6b is located on the lower side than the upper end of oil control valve 11 in the vehicle height direction. In this manner, the air can be easily guided to the front portion and lower portion of oil control valve 11, and thus the cooling effect can be enhanced.

Note that as illustrated in FIG. 3, resin clip 10 for routing wire harness 5 is fixed at flat portion 6b of air introduction member 6.

In addition to the above-described air introduction member 6, the vehicle of the present embodiment is provided with air stop plate 13 (see FIG. 3) as another characteristic component.

As illustrated in FIG. 3, air stop plate 13 is a plate-shaped member that is provided on the rear side than oil control valve 11 in the vehicle length direction, and extended along the vehicle height direction. Air stop plate 13 is fixed (e.g., welded) to bracket 14.

The air (see arrow B of FIG. 3) having reached oil control valve 11 through air introduction member 6 flows between the lower end of oil control valve 11 and bracket 14 so as to make contact with air stop plate 13. That is, the flow of the air is blocked by air stop plate 13. In this manner, the cooling effect of the rear portion (the left side portion of FIG. 3) of oil control valve 11 can be increased.

Note that as illustrated in FIG. 3, bracket 14 includes a flat portion that faces the lower end of oil control valve 11. In this manner, bracket 14 serves not only a role of fixing air stop plate 13, but also a role of blocking the heat from the components located on the lower side of oil control valve 11 (e.g., the exhaust manifold).

The vehicle of the present embodiment is described above. Now operations and effects of the present embodiment are described below.

A vehicle comprising: an internal combustion engine (not illustrated in the drawing) including a variable valve timing mechanism configured to change an opening/closing timing of a suction valve or an exhaust valve by driving oil control valve 11; and turbocharger 1 that compresses gas with a compressor on the same axis by rotating a turbine with exhaust gas from the internal combustion engine, and sends the gas into the internal combustion engine, oil control valve 11 is provided on a rear side than turbocharger 1 in a vehicle length direction and on a lower side than a top surface of turbocharger 1 in a vehicle height direction, the vehicle further comprises an air introduction member 6 provided between turbocharger 1 and oil control valve 11 in the vehicle length direction and having a shape that guides to oil control valve 11 air (e.g., arrow A of FIG. 1) flowing on an upper side of turbocharger 1 from a front side toward a rear side in the vehicle length direction.

With the above-described feature, the air with a low temperature and a high flow velocity flowing on the upper side of turbocharger 1 can be guided to oil control valve 11, and thus oil control valve 11 can be efficiently cooled.

In the vehicle according to the present embodiment, air introduction member 6 includes: protruding portion 6a that protrude to the upper side than the top surface of turbocharger 1 in the vehicle height direction, and flat portion 6b provided on the lower side than protruding portion 6a in the vehicle height direction and extended along the vehicle height direction.

With the above-described feature, the air can be efficiently guided from the upper side of turbocharger 1 toward oil control valve 11 located on the rear side and lower side of it.

In the vehicle according to the present embodiment, protruding portion 6a is tilted toward a front side in the vehicle length direction.

With the above-described feature, the air can be easily taken into protruding portion 6a, and the air having flown into protruding portion 6a can be smoothly guided to the lower direction.

In the vehicle according to the present embodiment, protruding portion 6a includes opening 60 facing the air flow direction and serving as an inlet of the air, and protruding portion 6a has a shape that surrounds an upper side portion and a left-right direction portion of opening 60.

With the above-described feature, the air having flown into air introduction member 6 from opening 60 can be prevented from diffusing to the upward side of the vehicle height direction and the vehicle width direction (left-right direction) side, and thus the air can be efficiently taken.

In the vehicle according to the present embodiment, a lower end of flat portion 6b is located on a lower side than an upper end of oil control valve 11 in the vehicle height direction.

With the above-described feature, air can be easily guided to the front portion and the lower portion of oil control valve 11 that tend to have high temperature, and thus the cooling effect can be enhanced.

The vehicle according to the present embodiment further includes air stop plate 13 provided on a rear side of oil control valve 11 in the vehicle length direction and extended along the vehicle height direction.

With the above-described feature, the air past oil control valve 11 can be blocked, and thus the cooling effect on the rear portion of oil control valve 11 can be increased.

The present disclosure is not limited to the description of the above embodiments, and various variations are possible without departing from the intent.

For example, in the present embodiment, oil control valve 11 is described as an example, but this is not limitative, and other valves (e.g., an electromagnetic valve) may be adopted.

This application is entitled to and claims the benefit of Japanese Patent Application No. 2022-011954 filed on Jan. 28, 2022, the disclosure each of which including the specification, drawings and abstract is incorporated herein by reference in its entirety.

### INDUSTRIAL APPLICABILITY

The vehicle and the cooling member of the present disclosure are suitable for cooling components that tend to have high temperature

### Reference Signs List

1 Turbocharger
2 Exhaust temperature sensor
3 Wire harness (branch line)
4 Vacuum pipe
5 Wire harness (trunk line)
6 Air introduction member
6a Protruding portion
6b Flat portion
7, 8 Bracket
10 Resin clip
11 Oil control valve
12 Wire harness
13 Air stop plate
14 Bracket
60 Opening
61 Top surface portion
62, 63 Side portion
64 Extending portion

1. A vehicle comprising:
an internal combustion engine including a variable valve timing mechanism configured to change an opening/closing timing of a suction valve or an exhaust valve by driving a valve; and
a turbocharger that compresses gas with a compressor on the same axis by rotating a turbine with exhaust gas from the internal combustion engine, and sends the gas into the internal combustion engine,
wherein the valve is provided on a rear side than the turbocharger in a vehicle length direction and on a lower side than a top surface of the turbocharger in a vehicle height direction, and
wherein the vehicle further comprises an air introduction member provided between the turbocharger and the valve in the vehicle length direction and having a shape that guides, to the valve, air flowing on an upper side of the turbocharger from a front side toward a rear side in the vehicle length direction.

2. The vehicle according to claim 1, wherein the air introduction member includes:
a protruding portion that protrudes to the upper side than the top surface of the turbocharger in the vehicle height direction, and
a flat portion provided on a lower side than the protruding portion in the vehicle height direction and extended along the vehicle height direction.

3. The vehicle according to claim 2, wherein the protruding portion is tilted toward a front side in the vehicle length direction.

4. The vehicle according to claim 2,
wherein the protruding portion includes an opening facing the air flow direction and serving as an inlet of the air, and
wherein the protruding portion has a shape that surrounds an upper side portion and a left-right portion of the opening.

5. The vehicle according to claim 2, wherein a lower end of the flat portion is located on a lower side than an upper end of the valve in the vehicle height direction.

6. The vehicle according to claim 1, further comprising an air stop plate provided on a rear side of the valve in the vehicle length direction and extended along the vehicle height direction.

7. A cooling member comprising:
an internal combustion engine including a variable valve timing mechanism configured to change an opening/closing timing of a suction valve or an exhaust valve by driving a valve; and
a turbocharger that compresses gas with a compressor on the same axis by rotating a turbine with exhaust gas from the internal combustion engine, and sends the gas into the internal combustion engine,
wherein the valve is provided on a rear side than the turbocharger in a vehicle length direction and on a lower side than a top surface of the turbocharger in a vehicle height direction, and
wherein the cooling member has a shape that guides, to the valve, air flowing on an upper side of the turbocharger from a front side toward a rear side in the vehicle length direction.
